(19) United States
(12) Patent Application Publication
(10) Pub. No.: US 2026/0165330 A1
(43) Pub. Date: Jun. 18, 2026

(54) BREAD, MIX FLOUR FOR BREAD, AND METHOD FOR MANUFACTURING BREAD

(71) Applicant: BASE FOOD, INC., Tokyo (JP)

(72) Inventor: Kengo HARATA, Tokyo (JP)

(21) Appl. No.: 19/124,887

(22) PCT Filed: Apr. 7, 2023
(86) PCT No.: PCT/JP2023/014436

§ 371 Date: Apr. 28, 2025

(30) Foreign Application Priority Data
Oct. 31, 2022 (JP) 2022-174830

(51) Int. Cl. A21D 13/064; A21D 2/14; A21D 2/26; A21D 10/00

(52) U.S. Cl. CPC A21D 13/064; A21D 2/145; A21D 2/265; A21D 10/002

(57) ABSTRACT

The present disclosure addresses the problem of providing a high-protein bread that maintains softness over time. A bread that has a protein content of 11.0 mass % or more and a salt content of 0.1-16.0 mass % inclusive relative to the protein content. A mix flour for bread that has a protein content of 11.0 mass % or more and a salt content of 0.1-16.0 mass % inclusive relative to the protein content. A method for producing bread, the method comprising heating a dough containing the mix flour for bread to give the bread having a protein content of 11.0 mass % or more.

### RELATED APPLICATIONS

The present application is a National Phase of International Application No. PCT/JP2023/014436 filed Apr. 7, 2023, which claims priority to Japanese Application No. 2022-174830, filed Oct. 31, 2022.

### TECHNICAL FIELD

The present invention relates to a bread, a mix flour for bread, and a method for producing a bread.

### BACKGROUND ART

Food is important to live healthy every day. For example, in Japan, “Japanese Food Guide Spinning Top”, which is jointly formulated by the Ministry of Health, Labour and Welfare and the Ministry of Agriculture, Forestry and Fisheries, recommends that each of the daily three meals be a well-balanced menu including a main dish, a side dish, and a soup as well as a staple food to take all necessary nutrients. As a reference value of the necessary nutrients, the Ministry of Health, Labour and Welfare determines an intake amount of energy and each nutrient in Dietary Reference Intakes for Japanese (2020) (for example, NPL 1). Such an intake reference for necessary nutrients is also formulated in foreign countries.

In order to maintain health, it is desirable to take necessary nutrients in the meal. For example, a bread containing a variety of nutrients in high content has been proposed (for example, PTL 1). Such a bread makes it possible to efficiently intake necessary nutrients without considering a menu, and shorten the time not only to prepare a meal but also to eat the meal.

### CITATION LIST

### Patent Literature

NPL 1: The Ministry of Health, Labour and Welfare, Dietary Reference Intakes for Japanese, Internet <URL:
   https://www.mhlw.go.jp/stf/seisakunitsuite/bunya/kenkou_iryou/kenkou/eiyou/syokuji_kijyun.html>
PTL 1: Japanese Patent Laid-open Publication No. 2022-125315

### SUMMARY OF INVENTION

### Technical Problem

In general, breads tend to have an impaired texture due to a change in hardness over time. In particular, a bread with a high protein content is more likely to be cured over time than a bread with a low protein content or no protein, and therefore can not keep its soft texture over time to result in, for example, an unpreferable texture such as difficulty in chewing, difficulty in eating, difficulty in swallowing, and poor melt-in-the-mouth texture.

An object of the present invention is to provide a high-protein bread that maintains softness over time.

### Solution to Problem

To solve the above problem, a main invention in the present invention is a bread including:
a protein in a content of 11.0 mass % or more; and
common salt in a content of 16.0 mass % or less with respect to the content of the protein.

Other problems disclosed in the present application and solutions thereof will be clarified in the section of the embodiments of the invention.

### Advantageous Effects of Invention

According to the present invention, it is possible to provide a high-protein bread that maintains softness over time. Furthermore, according to an embodiment of the present invention, a bread in which the content of a protein is 11.0 mass % or more and the content of common salt is reduced to 16.0 mass % or less with respect to the content of the protein can be improved in strange taste, excessive sweetness, milk fat flavor, and metal odor of the bread caused by reducing common salt, while maintaining softness over time.

### BRIEF DESCRIPTION OF DRAWINGS

FIG. 1 is a graph showing stress measurement results.

FIG. 2 is a graph showing strange taste strength.

### DESCRIPTION OF EMBODIMENTS

The content of embodiments of the present invention will be listed and described. The present invention has, for example, the following configurations.

### [Item 1]

A bread including:
a protein in a content of 11.0 mass % or more; and
common salt in a content of 0.1 mass % or more and 16.0 mass % or less with respect to the content of the protein.

### [Item 2]

The bread according to item 1, further including gluconic acid,
wherein the gluconic acid is contained in a mass ratio of 0.08 or more and 43.5 or less with respect to the common salt.

### [Item 3]

The bread according to item 2, wherein the common salt and the gluconic acid are contained in a total content of 0.4 mass % or more and 19.7 mass % or less with respect to the content of the protein.

### [Item 4]

The bread according to any one of items 1 to 3, having a stress of 2.0 N or more and 13.0 N or less.

### [Item 5]

The bread according to any one of items 1 to 4, wherein the protein is wheat protein.

### [Item 6]

A mix flour for bread including a protein and common salt,
wherein the common salt is contained in a content of 0.1 mass % or more and 16.0 mass % or less with respect to a content of the protein.

### [Item 7]

A method for producing a bread, the method including heating a dough containing the mix flour for bread according to item 6 to produce a bread containing the protein in a content of 11.0 mass % or more.

### [Item 8]

Use of common salt in a high-protein bread, wherein
in a bread containing a protein in a content of 11.0 mass % or more,
common salt is blended in a content of 0.1 mass % or more and 16.0 mass % or less with respect to the content of the protein.

### [Item 9]

Use of common salt and gluconic acid in a high-protein bread, wherein
in a bread containing a protein in a content of 11.0 mass % or more,
common salt is blended in a content of 0.1 mass % or more and 16.0 mass % or less with respect to the content of the protein, and
the gluconic acid is blended in a mass ratio of 0.08 or more and 43.2 or less with respect to the common salt.

### [Item 10]

A method of using common salt in a bread containing a protein in a content of 11.0 mass % or more, wherein the common salt is used in a content of 0.1 mass % or more and 16.0 mass % or less with respect to the content of the protein.

### [Item 11]

A method of using common salt and gluconic acid in a bread containing a protein in a content of 11.0 mass % or more, wherein
the common salt is used in a content of 0.1 mass % or more and 16.0 mass % or less with respect to the content of the protein, and
the gluconic acid is used in a ratio of 0.08 or more and 43.2 or less with respect to the common salt.

### 1. Bread

The bread of the embodiment includes: a protein in a content of 11.0 mass % or more; and common salt in a content of 0.1 mass % or more and 16.0 mass % or less with respect to the protein.

Such a bread is obtained, for example, by mixing and kneading a dough containing a mix flour for bread including a protein and common salt, wherein the common salt is contained in a content of 0.1 mass % or more and 16.0 mass % or less with respect to the protein to obtain a dough, and heating the dough. Hereinafter, substances contained in the bread of the embodiment and substances optionally contained in the bread will be described.

In the embodiment, the “bread” refers to, for example, those obtained as follows: wheat flour or those obtained by adding cereal flour thereto is/are used as a main raw material, added with yeast, optionally added with water, common salt, fruits such as grape, vegetable, egg or processed products thereof, sugars, edible fats and oils, milk, dairy products, and the like, and then kneaded (hereinafter, referred to as “bread dough” or simply “dough”), and fermented and baked, and the resultant has a moisture content of 10% or more (for example, the quality labeling standards for breads, the Ministry of Agriculture, Forestry and Fisheries).

In the embodiment, the “bread” means a fermented bread obtained by adding yeast to a flour containing the mix flour for bread, and inflating and baking the same. However, not only a fermented bread, but also those obtained by inflating a mixture with a gas-generating inflating agent such as baking powder or baking soda, and baking the same, and having a moisture content of 10% or more are called bread. Therefore, in the embodiment, a biscuit-type hard bread such as cone or hot biscuit is not included. In the embodiment, the “flour” may include wheat flour, rice flour, bean flour, and the like.

### 1.1. Protein

The bread of the embodiment is a high-protein bread in which a protein is contained in a content of 11.0 mass % or more in the bread.

As the content of the protein in the bread, the lower limit is 11.0 mass %, and may be 12.0 mass % or 13.0 mass %. The upper limit is, for example, 25.0 mass %, 24.0 mass %, or 23.0 mass %. The range is, for example, 11.0 to 25.0 mass %, 12.0 to 24.0 mass %, or 13.0 to 23.0 mass %. In addition, the content of the protein in the bread is 8.0 mass %, 9.0 mass %, 10.0 mass %, 11.0 mass %, 12.0 mass %, 13.0 mass %, 14.0 mass %, 15.0 mass %, 16.0 mass %, 17.0 mass %, 18.0 mass %, 19.0 mass %, 20.0 mass %, 21.0 mass %, 22.0 mass %, 23.0 mass %, 24.0 mass %, or 25.0 mass %, and any of these listed numerical values may be appropriately adopted as the upper limit or the lower limit. When the content of the protein in the bread is such a value, bread for one meal can contain at least ⅓ of the protein amount required per day, for example, at least ⅓ of 81 g, which is the nutrients labeling standard for men of 18 or older defined by the Ministry of Health, Labour and Welfare. In the present disclosure, the content of the protein in the bread is a ratio of proteins contained in the bread when the total mass of the bread is 100 mass %, and is a value obtained by quantifying the nitrogen amount in the bread using a combustion method total nitrogen measuring apparatus, and calculating from the nitrogen amount using a nitrogen-protein conversion coefficient.

In the embodiment, the protein is contained as one of the raw materials of the bread. The protein is the total amount of proteins contained in the following materials contained as a raw material, for example, wheat protein, beans, rice, cereal bran, wheat flour, and egg. When there are multiple protein sources, the amino acid score of the bread can be increased. The ratio of the content of the proteins is not particularly limited, but the content of wheat protein can be the highest.

Wheat protein is also called gluten, and is a protein in which glutenin and gliadin, each of which is a protein produced from endosperm of cereals, absorb water to be connected in a mesh shape. The dough of bread develops unique stickiness and elasticity due to gluten. When this dough is fermented, yeast generates “carbon dioxide gas”, and the dough swells (for example, the web site of The Federation of Japan Confectionery Associations,

https://gateaux.or.jp/ufaqs/% E3%82% BO % E3%83% AB % E3%83%86% E3%83% B3/).

Wheat protein is excellent in water absorbency, viscoelasticity, distensibility/extensibility, bondability, and thermocoagulability. For this reason, when the bread contains wheat protein, a flavor is imparted to the bread, and an elastic texture is produced.

As wheat protein, proteins constitute 70% or more of the wheat protein. Therefore, when the bread of the embodiment contains wheat protein as a raw material, the bread has a particularly high protein content.

Wheat protein has a high content of various minerals and dietary fibers. Therefore, when the bread of the embodiment contains wheat protein, it is possible to provide a bread having a high content of not only protein but also various minerals and dietary fibers.

The content of wheat protein in the bread is not particularly limited. The lower limit is, for example, 8.0 mass %, 9.0 mass %, or 10.0 mass %. The upper limit is, for example, 20.0 mass %, 19.0 mass %, or 18.0 mass %. The range is, for example, 8.0 to 20.0 mass %, 9.0 to 19.0 mass %, or 10.0 to 18.0 mass %. In addition, the content of wheat protein in the bread is 8.0 mass %, 9.0 mass %, 10.0 mass %, 11.0 mass %, 12.0 mass %, 13.0 mass %, 14.0 mass %, 15.0 mass %, 16.0 mass %, 17.0 mass %, 18.0 mass %, 19.0 mass %, or 20.0 mass %, and any of these listed numerical values may be appropriately adopted as the upper limit or the lower limit.

When the content of wheat protein is within the above range, elasticity and the like necessary for bread can be imparted, and the flavor and texture of bread can be enhanced while the water absorbency is in an appropriate range. When wheat protein is added in a dough in addition to the wheat flour described above, bread for one meal can contain at least ⅓ of the protein amount required per day, for example, at least ⅓ of 81 g, which is the nutrients labeling standard for men of 18 or older defined by the Ministry of Health, Labour and Welfare. Furthermore, it is possible to provide a bread having a high content of various minerals and dietary fibers. The content of wheat protein can be a total amount including the wheat protein contained in the wheat flour described later.

### 1.2. Common Salt

The bread of the embodiment includes common salt, and the content of the common salt in the bread is 0.1 mass % or more and 16.0 mass % or less with respect to the content of the protein contained in the bread.

Common salt has an important role in breadmaking. Examples of the role of common salt in breadmaking include improvement in breadmaking properties, suppression of over-fermentation by yeast, and improvement in storage properties. In addition, there are also roles of drawing out umami taste and sweet taste of raw materials such as wheat flour and imparting a flavor. On the other hand, too much common salt leads to excessive salt intake, which may be undesirable for people who restrict common salt intake.

The present inventors have found that when the content of the common salt in the bread is 0.1 mass % or more and 16.0 mass % or less with respect to the content of the protein contained in the bread, a bread having a high protein content can suppress temporal curing of the bread to maintain its soft texture, and the effect is remarkable, for example, as time passes after breadmaking.

As described above, usually, bread tends to be impaired in texture due to a change in hardness over time, and particularly, a bread having a high protein content is more likely to be cured over time than other breads. On the other hand, the bread of the embodiment, in which the content of common salt in the bread is 0.1 mass % or more and 16.0 mass % or less with respect to the content of the protein contained in the bread, can maintain the soft texture even after time passes.

The texture of the bread according to the embodiment can be expressed by, for example, stress or shear force. For example, in an aspect of the bread according to the embodiment, as the stress after two days from the preparation, the lower limit is, for example, 1.0 N, 1.5 N, or 2.0 N; the upper limit is, for example, 15.0 N, 14.0 N, 13.0 N, or 5.0 N; and the range is, for example, 1.0 to 15.0 N, 1.5 to 14.0 N, 2.0 to 13.0 N, or 2.0 to 5.0 N. When the stress satisfies the above range, the bread is easy to eat and has a good texture due to moderate softness. In addition, the stress of the bread after two days from the preparation is 1.0 N, 1.5 N, 2.0 N, 3.0 N, 4.0 N, 5.0 N, 6.0 N, 7.0 N, 8.0 N, 9.0 N, 10.0 N, 11.0 N, 12.0 N, 13.0 N, 14.0 N, or 15.0 N, and any of these listed numerical values may be appropriately adopted as the upper limit or the lower limit.

For example, in an aspect of the bread according to the embodiment, as the stress after three weeks from the preparation, the lower limit is, for example, 1.0 N, 1.5 N, 2.0 N, 7.0 N, or 8.0 N; the upper limit is, for example, 15.0 N, 14.0 N, or 13.0 N; and the range is, for example, 1.0 to 15.0 N, 1.5 to 14.0 N, 2.0 to 13.0 N, 7.0 to 15.0 N, or 8.0 to 14 N. When the stress satisfies the above range, the bread is easy to eat and has a good texture due to moderate softness. In addition, the stress of the bread after three weeks from the preparation is 1.0 N, 1.5 N, 2.0 N, 3.0 N, 4.0 N, 5.0 N, 6.0 N, 7.0 N, 8.0 N, 9.0 N, 10.0 N, 11.0 N, 12.0 N, 13.0 N, 14.0 N, or 15.0 N, and any of these listed numerical values may be appropriately adopted as the upper limit or the lower limit.

In the present disclosure, the stress of the bread is measured under the following conditions. A bread crumb cut into a length of 3 cm, a width of 3 cm, and a height of 1.5 cm is used as a sample. Using a rheometer (texture analyzer), a compression test is performed on the sample at the center of a pedestal under the condition that a plunger (φ20 mm, cylindrical, made of aluminum) is pushed down by 7.5 mm at a descending speed of 1 mm/sec and held for 10 sec, and the peak of stress at that time is determined as a measured value of stress.

As the content of common salt in the bread with respect to the content of the protein in the bread, the upper limit is 16.0 mass %, 15.0 mass %, 14.0 mass %, 10.0 mass %, 5.0 mass %, 4.0 mass %, or 1.0 mass %; the lower limit is, for example, 0.1 mass %, 0.2 mass %, or 0.3 mass %; and the range is, for example, 0.1 to 16.0 mass %, 0.2 to 15.0 mass %, 0.3 to 14.0 mass %, 0.3 to 10.0 mass %, 0.3 to 5.0 mass %, 0.3 to 4.0 mass %, or 0.3 to 1.0 mass %. In addition, the content of common salt in the bread with respect to the content of the protein is 0.1 mass %, 0.2 mass %, 0.3 mass %, 0.4 mass %, 8.0 mass %, 9.0 mass %, 10.0 mass %, 11.0 mass %, 12.0 mass %, 13.0 mass %, 14.0 mass %, 15.0 mass %, 16.0 mass %, 17.0 mass %, 18.0 mass %, 19.0 mass %, or 20.0 mass %, and any of these listed numerical values may be appropriately adopted as the upper limit or the lower limit. In the present disclosure, the content of common salt in the bread with respect to the content of the protein in the bread is a ratio of common salt contained in the bread when the content of the protein contained in the bread is 100 mass %.

When the content of common salt is within the above range, temporal curing of the bread is suppressed, and the soft texture can be maintained over time, and the effect is particularly remarkable in a bread having a high protein content or as time passes. Accordingly, the bread of the embodiment, in which the content of common salt in the bread is 0.1 mass % or more and 16.0 mass % or less with respect to the content of the protein in the bread, can maintain softness over time to keep preferable texture. The bread of the embodiment, capable of maintaining softness over time, for example, can be suitably applied to a long-life bread having a long expiration date of about one month.

### 1.3. Gluconic Acid

The bread of the embodiment may contain gluconic acid. As a suitable example of the case where the bread of the embodiment contains gluconic acid, the mass ratio of gluconic acid to common salt is 0.08 or more and 43.2 or less. In addition, as another suitable example of the case where the bread of the embodiment contains gluconic acid, the total amount of common salt and gluconic acid is 0.4 mass % or more and 19.7 mass % or less with respect to the protein in the bread.

When a bread contains common salt to bring out an umami taste and a sweet taste of the raw materials, and the content of common salt is reduced so that the bread has a rich flavor and a deep taste, as a result, a strange taste that is considered to be derived from the raw materials of the bread (for example, excessive sweetness that is considered to be derived from a sugar decomposition product, milk fat flavor, a metal odor, and the like) may become conspicuous. This time, it has been found that when the mass ratio of gluconic acid is 0.08 or more and 43.5 or less with respect to common salt and/or the total amount of common salt and gluconic acid is 0.4 mass % or more and 19.7 mass % or less with respect to the protein in the bread, the strange taste caused by reducing common salt can be suppressed.

The strange taste of the bread according to the embodiment can be expressed by, for example, strange taste strength. The strange taste strength can be expressed by the following 1 to 9 point scale based on sensory evaluation.
1: No strange taste is felt.
2: Almost no strange taste is felt.
3: Very slight strange taste is felt.
4: Slight strange taste is felt.
5: Strange taste is felt.
6: Slightly strong strange taste is felt.
7: Strong strange taste is felt.
8: Considerably strong strange taste is felt.
9: Very strong strange taste is felt.

As for the bread of the embodiment, the lower limit of the strange taste strength is, for example, 1.5, 1.8, or 2.0; the upper limit is, for example, 7.0, 6.7, or 6.5; and the range is, for example, 1.5 to 7.0, 1.8 to 6.7, or 2.0 to 6.5. In addition, the strange taste strength of the bread is, for example, 1.5, 1.8, 2.0, 3.0, 4.0, 5.0, 6.0, 6.5, 6.7, or 7.0, and any of these listed numerical values may be appropriately adopted as the upper limit or the lower limit. When the strange taste strength is within the above range, it can be determined that the bread has a preferred flavor and texture.

In the bread of the embodiment, gluconic acid can be derived from an alkali metal salt of gluconic acid such as potassium gluconate or sodium gluconate. For example, the bread of the embodiment preferably contains gluconic acid derived from potassium gluconate by using potassium gluconate as a raw material. When potassium gluconate is used as a raw material, it is possible to serve as a potassium source and to suppress the strange taste of bread caused by reducing common salt. Potassium gluconate as a raw material may be used in place of a part or all of other raw materials serving as a potassium source.

As for the mass ratio of gluconic acid with respect to common salt, the lower limit of is, for example, 0.08, 0.1, 0.2, or 10.0; the upper limit is, for example, 21.8, 43.2, 43.5, or 44.0; and the range is, for example, 0.08 to 43.5 or 0.08 to 43.2. In particular, when the mass ratio of gluconic acid with respect to common salt satisfies 0.2 to 43.5 or 0.2 to 43.2, particularly 10.0 to 43.5 or 10.0 to 43.2, it is possible to remarkably effectively suppress the strange taste caused by reducing the content of common salt. In addition, the mass ratio of gluconic acid with respect to common salt is, for example, 0.05, 0.07, 0.08, 0.1, 0.2, 0.5, 1.0, 1.5, 2.0, 3.0, 4.0, 5.0, 6.0, 7.0, 8.0, 9.0, 10.0, 11.0, 12.0, 13.0, 14.0, 15.0, 16.0, 17.0, 18.0, 19.0, 20.0, 21.0, 22.0, 23.0, 24.0, 25.0, 26.0, 27.0, 28.0, 29.0, 30.0, 31.0, 32.0, 33.0, 34.0, 35.0, 36.0, 37.0, 38.0, 39.0, 40.0, 41.0, 42.0, 10.9, 21.8, 43.0, 43.2, 43.5, or 44.0, and any of these listed numerical values may be appropriately adopted as the upper limit or the lower limit. In the present disclosure, the mass ratio of gluconic acid with respect to common salt is a ratio of the content of gluconic acid contained in the bread when the content of common salt contained in the bread is 1. When an alkali metal salt of gluconic acid is used as a raw material of gluconic acid, the mass ratio of gluconic acid with respect to common salt is a value obtained by subtracting the content of the alkali metal salt from the content of the alkali metal salt of gluconic acid contained in the bread. For example, when the content of potassium gluconate is 1, the value is 0.833 in terms of the content of gluconic acid.

As for the total content of gluconic acid and common salt in the bread with respect to the content of the protein in the bread, the lower limit is, for example, 0.3 mass %, 0.4 mass %, 0.5 mass %, or 3.9 mass %; the upper limit is 19.7 mass %, 19.5 mass %, or 14.5 mass %; and the range is, for example, 0.3 to 19.7 mass %, 0.4 to 19.7 mass %, 0.5 to 19.5 mass %, or 0.4 to 14.5 mass %. In particular, when the total content of gluconic acid and common salt in the bread satisfies 3.9 to 14.5 mass % with respect to the content of the protein in the bread, it is possible to remarkably effectively suppress the strange taste caused by reducing the content of common salt. In addition, the total content of gluconic acid and common salt in the bread with respect to the content of the protein in the bread is 0.3 mass %, 0.4 mass %, 0.5 mass %, 0.6 mass %, 0.7 mass %, 0.8 mass %, 0.9 mass %, 1.0 mass %, 2.0 mass %, 3.0 mass %, 3.9 mass %, 4.0 mass %, 5.0 mass %, 6.0 mass %, 7.0 mass %, 8.0 mass %, 9.0 mass %, 10.0 mass %, 11.0 mass %, 12.0 mass %, 13.0 mass %, 14.0 mass %, 14.5 mass %, 15.0 mass %, 16.0 mass %, 17.0 mass %, 18.0 mass %, 19.0 mass %, 19.5 mass %, or 19.7 mass %, and any of these listed numerical values may be appropriately adopted as the upper limit or the lower limit. In the present disclosure, the total content of gluconic acid and common salt in the bread with respect to the protein in the bread is a ratio of the total content of gluconic acid and common salt contained in the bread when the content of the protein contained in the bread is 100 mass %. When an alkali metal salt of gluconic acid is used as a raw material of gluconic acid, the total content of gluconic acid and common salt in the bread is the total of: a value obtained by subtracting the content of the alkali metal salt from the content of the alkali metal salt of gluconic acid contained in the bread; and the content of common salt.

As for the mass ratio of potassium gluconate with respect to common salt, the lower limit of is, for example, 0.08, 0.1, 0.2, or 13.1; the upper limit is, for example, 53.0, 52.2, 52.0, or 51.0; and the range is, for example, 0.08 to 53.0, 0.1 to 52.0, 0.2 to 51.0, or 0.2 to 52.2. In particular, when the mass ratio of potassium gluconate with respect to common salt satisfies 13.1 to 52.2, it is possible to remarkably effectively suppress the strange taste caused by reducing the content of common salt. In addition, the mass ratio of potassium gluconate with respect to common salt is, for example, 0.08, 0.1, 0.2, 0.5, 1.0, 1.5, 2.0, 3.0, 4.0, 5.0, 6.0, 7.0, 8.0, 9.0, 10.0, 11.0, 12.0, 13.0, 13.1, 14.0, 15.0, 16.0, 17.0, 18.0, 19.0, 20.0, 21.0, 22.0, 23.0, 24.0, 25.0, 26.0, 27.0, 28.0, 29.0, 30.0, 31.0, 32.0, 33.0, 34.0, 35.0, 36.0, 37.0, 38.0, 39.0, 40.0, 41.0, 42.0, 43.0, 44.0, 45.0, 46.0, 47.0, 48.0, 49.0, 50.0, 51.0, 52.0, 52.2, or 53.0, and any of these listed numerical values may be appropriately adopted as the upper limit or the lower limit. In the present disclosure, the mass ratio of potassium gluconate with respect to common salt is a ratio of the content of potassium gluconate contained in the bread when the content of common salt contained in the bread is 1.

As for the total content of potassium gluconate and common salt in the bread dough with respect to the content of the protein in the bread, the lower limit is, for example, 0.3 mass %, 0.4 mass %, 0.5 mass %, or 4.6 mass %; the upper limit is 24.0 mass %, 23.5 mass %, 23.0 mass %, or 17.4 mass %; and the range is, for example, 0.3 to 23.5 mass %, 0.4 to 23.5 mass %, 0.5 to 23.0 mass %, 0.3 to 17.4 mass %, or 0.4 to 17.4 mass %. In particular, when the total content of potassium gluconate and common salt in the bread satisfies 4.6 to 17.4 mass % with respect to the content of the protein in the bread, it is possible to remarkably effectively suppress the strange taste caused by reducing the content of common salt. In addition, the total content of potassium gluconate and common salt in the bread with respect to the content of the protein in the bread is, for example, 0.3 mass %, 0.4 mass %, 0.5 mass %, 0.6 mass %, 0.7 mass %, 0.8 mass %, 0.9 mass %, 1.0 mass %, 2.0 mass %, 3.0 mass %, 4.0 mass %, 4.6 mass %, 5.0 mass %, 6.0 mass %, 7.0 mass %, 8.0 mass %, 9.0 mass %, 10.0 mass %, 11.0 mass %, 12.0 mass %, 13.0 mass %, 14.0 mass %, 15.0 mass %, 16.0 mass %, 17.0 mass %, 17.4 mass %, 18.0 mass %, 19.0 mass %, 20.0 mass %, 21.0 mass %, 22.0 mass %, 23.0 mass %, 23.5 mass %, or 24.0 mass %, and any of these listed numerical values may be appropriately adopted as the upper limit or the lower limit. In the present disclosure, the total content of potassium gluconate and common salt in the bread with respect to the protein in the bread is a ratio of the total content of potassium gluconate and common salt contained in the bread when the content of the protein contained in the bread is 100 mass %.

When the content of gluconic acid or potassium gluconate is within the above range, it is possible to suppress the strange taste of bread caused by reducing common salt. This makes it possible to provide a bread in which temporal curing of bread due to reduction of common salt is suppressed, the soft texture is maintained even after elapse of time, and strange taste is suppressed.

### 1.4. Wheat Flour

The bread of the embodiment may contain wheat flour as a raw material. Wheat flour is generally a raw material serving as a main raw material of bread dough, and contains a lot of carbohydrates. Therefore, when the bread dough contains wheat flour, it is possible to provide a bread serving as a staple food serving as a source of energy.

Wheat flour contains the above-mentioned wheat protein as a protein in an amount of about 6 to 15 mass %, but does not contain vitamins and minerals in a large amount. Therefore, through breadmaking in combination with each raw material described in the present specification, it is possible to provide a bread containing an appropriate content of sugar and containing a variety of nutrients in high content. Here, the sugar is obtained by excluding dietary fibers from carbohydrates.

In the embodiment, wheat flour may be milled wheat flour or whole wheat flour. The whole wheat flour contains the wheat bran or the like as the bran, and the ratio thereof is about 15 mass %. Therefore, when whole wheat flour is used as wheat flour, vitamins, minerals, lipids, proteins, and dietary fibers can be supplemented to the bread according to the embodiment. The whole wheat flour contains about 10 to 13 mass % of the wheat protein.

In the embodiment, either hard wheat or soft wheat may be used as wheat flour, and any of weak flour, medium flour, or strong flour may be used. Among them, in order to improve the texture of bread, it is preferable to use strong flour as wheat flour.

As for the content of wheat flour in the bread dough, the lower limit is, for example, 10.0 mass %, 11.0 mass %, or 12.0 mass %; the upper limit is, for example, 46.3 mass %, 25.0 mass %, 24.0 mass %, or 23.0 mass %; and the range is, for example, 10.0 to 46.3 mass %, 10.0 to 25.0 mass %, 11.0 to 24.0 mass %, or 12.0 to 23.0 mass %. In addition, the content of wheat flour in the bread dough is, for example, 10.0 mass %, 11.0 mass %, 12.0 mass %, 13.0 mass %, 14.0 mass %, 15.0 mass %, 16.0 mass %, 17.0 mass %, 18.0 mass %, 19.0 mass %, 20.0 mass %, 21.0 mass %, 22.0 mass %, 23.0 mass %, 24.0 mass %, 25.0 mass %, or 46.3 mass %, and any of these listed numerical values may be appropriately adopted as the upper limit or the lower limit. When the content of wheat flour is within the above range, carbohydrate can be supplied to the bread, and the flavor of the bread can be enhanced. In the present disclosure, the content of wheat flour in the bread dough is a ratio of the content of wheat flour contained in the bread dough when the amount of the bread dough used for producing the bread of the embodiment is 100 mass %.

### 1.5. Bean

The bread of the embodiment may contain bean flour as a raw material. As for the content of bean flour in the bread dough, the lower limit is, for example, 3.0 mass %, 4.0 mass %, or 5.0 mass %; the upper limit is, for example, 16.0 mass %, 15.0 mass %, or 14.0 mass %; and the range is, for example, 3.0 to 16.0 mass %, 4.0 to 15.0 mass %, or 5.0 to 14.0 mass %. In addition, the content of bean flour in the bread dough is, for example, 3.0 mass %, 4.0 mass %, 5.0 mass %, 6.0 mass %, 7.0 mass %, 8.0 mass %, 9.0 mass %, 10.0 mass %, 11.0 mass %, 12.0 mass %, 13.0 mass %, 14.0 mass %, 15.0 mass %, or 16.0 mass %, and any of these listed numerical values may be appropriately adopted as the upper limit or the lower limit. The bean can be appropriately selected depending on the application, but soybean is preferable as a source of protein and dietary fiber, and pea is preferable for improving the texture. In the present disclosure, the content of bean flour in the bread dough is a ratio of the content of bean flour contained in the bread dough when the amount of the bread dough used for producing the bread of the embodiment is 100 mass %.

Soybean is rich in protein and lipid, and has the highest protein content among beans. Therefore, when the bread contains, for example, 5.0 mass % or more and 10.0 mass % or less of soybean in the dough, it is particularly possible to provide a bread not only containing protein and lipid in a high content, but also containing various minerals and dietary fibers in a high content, and having high flavor and texture.

### 1.6. Cereal Bran

The bread of the embodiment may contain cereal bran as a raw material. As the content of cereal bran in the bread dough, the lower limit is, for example, 1.0 mass %, 2.0 mass %, or 3.0 mass %; the upper limit is, for example, 10.0 mass %, 9.0 mass %, or 8.0 mass %; and the range is, for example, 1.0 to 10.0 mass %, 2.0 to 9.0 mass %, or 3.0 to 8.0 mass %. In addition, the content of cereal bran in the bread dough is, for example, 1.0 mass %, 2.0 mass %, 3.0 mass %, 4.0 mass %, 5.0 mass %, 6.0 mass %, 7.0 mass %, 8.0 mass %, 9.0 mass %, or 10.0 mass %, and any of these listed numerical values may be appropriately adopted as the upper limit or the lower limit. When the dough contains cereal bran within such a range, lipids, dietary fibers, and other nutrients can be supplemented to the bread, and further, the flavor and texture of the bread can be enhanced. For example, when the wheat flour is whole wheat flour, the content of the bran can be a total amount including wheat bran as the bran portion included in the whole wheat flour. In the present disclosure, the content of cereal bran in the bread dough is a ratio of the content of cereal bran contained in the bread dough when the amount of the bread dough used for producing the bread of the embodiment is 100 mass %.

The bran refers to a part such as pericarp or seed coat that appears when cereal is milled. For example, in the case of rice and glutinous rice, the bran mainly includes germ, perisperm, and aleurone layer of brown rice, which is obtained by removing rice hull from seeds. In the case of wheat varieties such as wheat and secale, the bran includes epiderm parts such as pericarp or seed coat.

The cereal bran is rich in nutrients that are hardly contained in milled cereal. Therefore, when the bread contains cereal bran, it is possible to supplement various nutrients, and furthermore, to impart flavor and texture to the bread from components peculiar to bran.

Examples of cereal as a raw material of cereal bran include wheat, rice, corn, barley, oats, secale, adlay, sorghum, Setaria italica, common millet, barnyard millet, buckwheat, kaoliang, triticale, bulgur, quinoa, amaranthus, and the like. The barley may be mochi mugi. These cereal brans may be used singly or in combination of two or more kinds thereof.

The type of rice for obtaining rice bran is not limited, and includes, for example, paddy rice, upland rice, glutinous rice, red rice, black rice, green rice, and the like. These can be appropriately selected in order to impart desired characteristics to the bread.

Among cereal brans, brans of wheat, secale, and rice are preferable. That is, it is preferable to use wheat bran, secale bran, and rice bran as the cereal bran. Since bran is often discarded in the process of milling cereal, brans of wheat, secale, and rice are particularly easily available. Therefore, nutrient-rich raw materials can be obtained at low cost. In addition, brans of wheat, secale, and rice are preferable also from the viewpoint of the type and content of various nutrients, flavor, and the like.

### 1.7. Wheat Germ

The bread of the embodiment may contain wheat germ as a raw material. Wheat germ serves as a source of dietary fiber, lipid, protein, various vitamins and minerals, and also imparts flavor and texture to the bread.

As for the content of wheat germ in the bread dough, the lower limit is, for example, 0.5 mass %, 1.0 mass %, or 1.5 mass %; the upper limit is, for example, 5.0 mass %, 4.5 mass %, or 4.0 mass %; and the range is, for example, 0.5 to 5.0 mass %, 1.0 to 4.5 mass %, or 1.5 to 4.0 mass %. In addition, the content of wheat germ in the bread dough is, for example, 0.5 mass %, 1.0 mass %, 1.5 mass %, 2.0 mass %, 2.5 mass %, 3.0 mass %, 3.5 mass %, 4.0 mass %, 4.5 mass %, or 5.0 mass %, and any of these listed numerical values may be appropriately adopted as the upper limit or the lower limit. When the dough contains wheat germ within such a range, lipids, dietary fibers, and other nutrients can be supplemented to the bread, and further, the flavor and texture of the bread can be enhanced. In the present disclosure, the content of wheat germ in the bread dough is a ratio of the content of wheat germ contained in the bread dough when the amount of the bread dough used for producing the bread of the embodiment is 100 mass %.

### 1.8. Egg

The bread of the embodiment may contain egg as a raw material. Egg is rich in protein and lipid, and is used to obtain a bread excellent in flavor and texture. In addition, lecithin, which is an egg yolk lipoprotein in egg yolk, makes it possible to stabilize the dough by uniformly mixing the raw materials, and to enhance the water retainability of the dough, thereby making it possible to make a bread more excellent in flavor and texture.

### 1.9. Seaweed

The bread of the embodiment may contain seaweed as a raw material. Seaweed is rich in alginic acid and fucoidan, which are water-soluble dietary fibers, thus supplementing the bread with dietary fiber. In addition, when the bread abundantly contains dietary fibers, the bread is improved in feeling of fullness of the bread, and has a property of gelling moisture in the bread, increasing the water holding capacity of the dough.

Furthermore, seaweed is rich in minerals such as calcium and iodine, and therefore can supplement the bread with minerals. Furthermore, since seaweed is rich in glutamic acid, which is a umami component, the flavor of the bread is enhanced by containing seaweed in the bread.

Examples of the seaweed include kelp, tengusa, gracilaria, wakame, and mozuku. These may be used singly or in combination of two or more kinds thereof. Among them, the seaweed is preferably kelp, and can supplement the bread with dietary fiber and impart a desired flavor and texture to the bread.

### 1.10. Seed

The bread of the embodiment may contain seed as a raw material. The seed is a generic term for edible fruits and seeds coated in a hard peel or shell, and is also called nut. The seed is rich in proteins and lipids and has a relatively low amount of carbohydrate. In addition, the seed is rich in dietary fiber, and various vitamins and minerals. Therefore, when the bread contains seed, it is possible to supplement the bread with various nutrients, and furthermore, to impart flavor and texture to the bread from components peculiar to various seeds.

Examples of the seed include almond, cashew nut, pecan nut, brazil nut, macadamia nut, pistachio, hazelnut, coconut, pine nut, sunflower seed, pumpkin seed, watermelon seed, Japanese chinquapin, walnut, sesame, linseed, hemp seed (hemp), perilla, poppy, buckeye, lotus, pine nut, peanut, and cacao. These may be used singly or in combination of two or more kinds thereof.

### 1.11. Yeast

The bread of the embodiment may contain yeast as a raw material. Yeast not only ferments and softly inflates dough, but also serves as a source of various vitamins including vitamin B group, minerals, amino acids, nucleic acids, dietary fibers, and the like. The dough containing yeast increases the flavor of the bread.

Examples of the yeast include baker's yeast (Saccharomyces cerevisiae bacteria, so-called yeast) and beer's yeast. In particular, in the embodiment, the dough may contain baker's yeast for the purpose of inflating the bread, and serving as a supply source of vitamin B group or the like. Further, other yeasts can be used in combination according to desired properties.

The baker's yeast may be any of yeast, wild yeast, and natural yeast. The yeast may be a dry yeast, an instant dry yeast, or a fresh yeast. These may be used singly or in combination of two or more kinds thereof.

### 1.12. Food Containing Glucomannan

The bread of the embodiment may contain food containing glucomannan as a raw material. Glucomannan is a water-soluble dietary fiber abundantly contained in cell walls of conifers and konjac potato, and serves as a source of dietary fiber to the bread. In addition, it can be expected to impart functions such as emulsion stability, freezing resistance, and reduction of water separation to the bread dough, and the flavor and texture of the bread can be enhanced. Examples of the food containing glucomannan include chia seeds and konjac powder.

### 1.13. Oil and Fat

The bread of the embodiment may contain oil and fat as a raw material. The oil and fat adds rich flavor to the taste of the bread, and softens the texture. In addition, when a bread dough is molded and baked, the dough is inflated in an oven to increase the volume of the bread, and a softly baked bread is obtained. Furthermore, oil and fat has a function of confining moisture in bread dough, preventing drying, and slowing down aging.

Examples of the oil and fat include butter, animal fat, and vegetable oil. The butter may be salted butter, saline-free butter, or fermented butter. Examples of the animal fat include beef tallow and lard. Examples of the vegetable oil include linseed oil, perilla oil, olive oil, sesame oil, rice bran oil, safflower oil, soybean oil, formulated oil, corn oil, rapeseed oil, palm oil, palm kernel oil, sunflower oil, grape oil, cottonseed oil, coconut oil, and peanut oil. Alternatively, margarine or shortening may be used. Among them, butter can be used because butter is particularly excellent in flavor and contains vitamin A.

As for the content of oil and fat in the bread dough, the lower limit is, for example, 0.5 mass %, 1.0 mass %, 1.5 mass %, or 2.48 mass %; the upper limit is, for example, 7.80 mass %, 5.0 mass %, 4.5 mass %, or 4.0 mass %; and the range is, for example, 0.5 to 5.0 mass %, 1.0 to 4.5 mass %, or 1.5 to 4.0 mass %. In addition, the content of oil and fat in the bread dough is 0.5 mass %, 1.0 mass %, 1.5 mass %, 2.0 mass %, 2.5 mass %, 3.0 mass %, 3.5 mass %, 4.0 mass %, 4.5 mass %, 5.0 mass %, or 7.80 mass %, and any of these listed numerical values may be appropriately adopted as the upper limit or the lower limit. When the dough contains oil and fat within such a range, the flavor and texture of the bread can be enhanced.

### 1.14. Other Raw Materials

The bread of the embodiment may contain components other than the raw materials listed above as raw materials. Other raw materials are not particularly limited, and examples thereof include raw materials used for conventionally known bread doughs, and raw materials for imparting vitamins, minerals, and the like to food, or imparting flavor and texture. Examples thereof include malt, maltose, rice flour, glutinous rice flour, potatoes, vegetable, starch, and saccharides such as sugar, bittern, dairy products, gelatin, tea leaves, and spirit. In addition, a so-called super hood may be included. When the bread is not a fermented bread, baking powder or baking soda can be contained as an inflating agent.

The rice flour may be brown rice flour, and the brown rice flour may be germinated brown rice flour. Examples of the potatoes include potato, taro, sweet potato, yacon, and Jerusalem artichoke. Examples of the vegetable include squash, lotus root, and carrot, each of which has a large amount of carbohydrate. Examples of the starch include potato starch, cassava starch, and the like. Examples of the saccharides include white sugar, brown sugar, wasanbon-to sugar, yellow soft sugar, processed sugar, liquid sugar, powder candy, starch syrup, glucose, fructose, isomerized liquid sugar, brown sugar syrup, honey, maple syrup, sugar cane extract, and reduced starch syrup. Examples of salt include common salt, purified salt, and rock salt. Examples of dairy products include raw milk, processed milk, whole milk powder, skimmed milk powder, fresh cream, yoghurt, cheese, whey powder, and the like. These may be used singly or in combination of two or more kinds thereof.

### 1.15. Method for Producing Bread

The method for producing a bread of the embodiment includes heating a dough containing a mix flour for bread containing a protein and common salt, wherein the common salt is contained in a content of 16.0 mass % or less with respect to the content of the protein.

That is, the bread of the embodiment is obtained as follows: a mix flour for bread containing an appropriate amount of proteins and common salt is added with other raw materials in an arbitrary order; the mixture is kneaded to obtain a dough; the dough is fermented and then molded, and further fermented as necessary; and then the dough is fired by heating at an arbitrary temperature. The heating is performed using a heating means for heating a dough, for example, a bread-making apparatus having a baking furnace such as an oven.

More specifically, the dough may be prepared by mixing raw materials other than oil and fat, then adding oil and fat, and mixing and kneading the mixture. The prepared dough may be subjected to the steps of floor time (primary fermentation) as necessary, dividing and rounding, bench time as necessary, molding, and toasting (secondary fermentation) as necessary, and then subjected to a firing step. After the firing step, cooling is performed, and bagging may be performed as necessary.

The method makes it possible to provide a high-protein bread containing a protein in a content of 11.0 mass % or more; and common salt in a content of 16.0 mass % or less with respect to the content of the protein, thereby maintaining softness over time.

### 2. Examples

Hereinafter, the present invention will be described with reference to examples and comparative examples, but the present invention is not limited to these examples. Note that “%” is on a mass basis.

### 2.1. Test 1

### 2.1.1. Production of Bread

Raw materials were prepared at the blending ratio shown in Table 1, and roll breads were prepared so that the final product weighed 70 to 75 g. Specifically, first, raw materials other than butter (wheat flour, wheat protein, baker's yeast, common salt, whole egg, water, potassium gluconate) were put into a mixer and mixed at a low speed for 4 minutes and at a high speed for 2 minutes. Butter was then added and mixed at low speed for 2 minutes and at high speed for 7 minutes to make a dough. The dough was divided into 83 g, and rolled by hand at 30 to 40 revolutions as a guide so that the dough was molded. The molded dough was placed on a top plate, and floor time was taken at a temperature of 27° C. and a humidity of 75% RH for 60 minutes. Thereafter, fermentation was performed at a temperature of 38° C. and a humidity of 85% RH for 60 minutes. Next, the dough was fired in an oven at an upper flame of 190° C. and a lower flame of 190° C. for 24 minutes, and then cooled at normal temperature for 40 minutes. The resulting bread was then packaged with a quality retention agent (“Negamold”, Freund Corporation).

TABLE 1

| Test section No. | 1 | 2 | 3 | 4 |
|---|---|---|---|---|
| Wheat flour | 78 | 78 | 78 | 78 |
| Wheat protein | 22 | 22 | 22 | 22 |
| Baker's yeast | 2.9 | 2.9 | 2.9 | 2.9 |
| Common salt | 0.43 | 0.43 | 1.3 | 1.3 |
| Whole egg | 8.5 | 8.5 | 8.5 | 8.5 |
| Water | 52.7 | 52.7 | 52.7 | 52.7 |
| Butter | 4.3 | 4.3 | 4.3 | 4.3 |
| Potassium gluconate | 0 | 1.7 | 0 | 3.4 |

The numerical values in the table are mass ratio.

### 2.1.2. Protein Analysis

The protein in the bread was analyzed by the combustion method. Specifically, first, the bread was crushed with a crusher. Then 200 to 400 mg of the crushed bread was accurately weighed to the fourth unit after the decimal point and used as a sample. The sample was burned using a combustion method total nitrogen measuring apparatus (SUMIGRAPH NC-TRINITY, Sumika Chemical Analysis Service, Ltd.) to convert nitrogen in the sample into nitrogen oxide. Subsequently, the nitrogen oxide was reduced to nitrogen with a combustion method total nitrogen measuring apparatus. Similarly, nitrogen was separated from the combustion products with a combustion method total nitrogen measuring apparatus, and the amount of nitrogen was quantified. A standard for preparing a calibration curve, which was accurately weighed in advance to a unit of 0.0001 mg, was measured to prepare a calibration curve, and the nitrogen content (g/100 g) in the sample was calculated from the calibration curve. Using 6.25 as a nitrogen-protein conversion coefficient, the protein amount was calculated by multiplying the nitrogen content by 6.25. For the protein, the final product of Test section No. 3 was measured at N=3. The protein measurement result was 13.98 g/100 g on average. Using the value, the ratio of each of common salt, gluconic acid, and potassium gluconate with respect to the protein in each bread was calculated.

### 2.1.3. Stress Measurement of Bread

The stress of the bread was measured 2 days and 3 weeks after the bread was produced by the following apparatus and measurement method. The bread was stored at normal temperature. The stress of the bread was measured by a compression test using a rheometer (Texture Analyzer “EZ-SX”, manufactured by SHIMADZU) and using a sample obtained by cutting the crumb of the bread into a size of a length of 3 cm, a width of 3 cm, and a height of 1.5 cm. Specific conditions are as follows. The sample was placed at the center of a pedestal, and a plunger (φ20 mm, cylindrical, made of aluminum) was pushed down by 7.5 mm at a descending speed of 1 mm/sec, and held for 10 sec, and the peak of stress at that time was determined as a measured value of stress.

### 2.1.4. Measurement of Strange Taste Strength

Sensory evaluation was performed for the strange taste of the bread. In the sensory evaluation, the obtained roll bread was cut into 12 equal pieces, and eaten such that one piece was eaten at a time. An unpalatable taste derived from the blended raw materials was regarded as strange taste, and the strange taste strength was evaluated on the following scale of 1 to 9 points. The evaluation was performed by 8 persons skilled in the sensory test of taste, the sensory evaluation was performed without explicitly indicating the content of each sample, and the average value thereof was calculated.
1: No strange taste is felt.
2: Almost no strange taste is felt.
3: Very slight strange taste is felt.
4: Slight strange taste is felt.
5: Strange taste is felt.
6: Slightly strong strange taste is felt.
7: Strong strange taste is felt.
8: Considerably strong strange taste is felt.
9: Very strong strange taste is felt.

### 2.1.5. Results

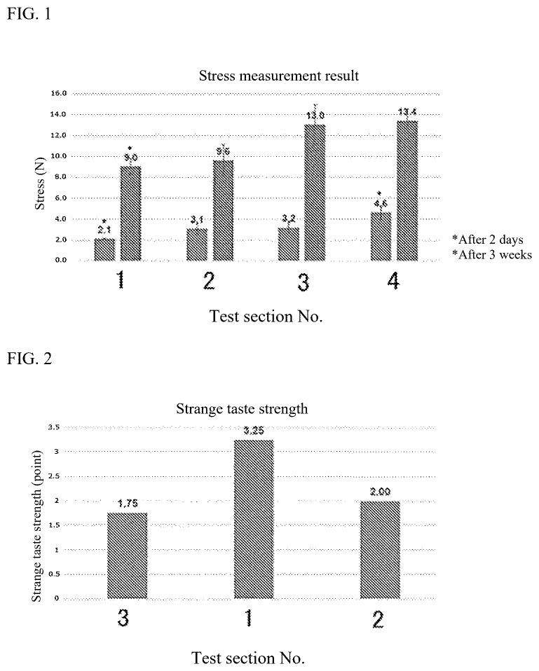

Table 2 shows the ratio of the content of common salt, the content of gluconic acid, and the content of potassium gluconate, each with respect to the content of protein, the mass ratio of gluconic acid with respect to common salt, the total content of common salt and gluconic acid, stress measurement results, and strange taste strength. FIG. 1 is a graph showing stress measurement results. FIG. 2 is a graph showing strange taste strength.

TABLE 2

| | | | Content of | | | | | |
|---|---|---|---|---|---|---|---|---|
| | Content of | Content of | potassium | Mass ratio | Total content | | | |
| | common salt | gluconic acid | gluconate with | of gluconic | of common | Stress | Stress | |
| Test | with respect | with respect | respect to | acid with | salt and | measurement | measurement | Strange |
| section | to content | to content | content of | respect to | gluconic | result (2 | result (3 | taste |
| No. | of protein | of protein | protein | common salt | acid | days after) | weeks after) | strength |
| 1 | 1.1% | 0.0% | 0.0% | 0 | 1.1% | 2.1N | 9.0N | 3.25 |
| 2 | 1.1% | 3.8% | 4.6% | 3.29 | 4.9% | 3.1N | 9.6N | 2.00 |
| 3 | 3.5% | 0.0% | 0.0% | 0 | 3.5% | 3.2N | 13.0N | 1.75 |
| 4 | 3.5% | 7.6% | 9.1% | 2.18 | 11.1% | 4.6N | 13.4N | — |

As shown in Table 2 and FIG. 1, Test section No. 1 and 2, in which the ratio of common salt was 1.1% with respect to protein, resulted in smaller stress than Test section No. 3 and 4, in which the ratio of common salt was 3.5% with respect to protein. This result was remarkable 3 weeks after the bread was produced, rather than 2 days after the bread was produced.

As shown in Table 2 and FIG. 2, the strange taste strength was the lowest in Test section No. 3, in which the ratio of common salt was 3.5% with respect to protein. For Test section No. 3, there were comments such as “Sweet taste was not felt, salty taste was felt, and deliciously eaten without acridity”. In Test section No. 1, in which the bread had low stress, the strange taste strength was increased due to reduction in the amount of common salt. For Test section No. 1, there were comments such as “Sweet taste stood out, sweet taste for milk, slightly excessive sweetness with flavor like corn or soybean and uncomfortable feeling, unpreferable steaming taste was felt, unpalatable aftertaste, and metallic taste”. On the other hand, Test section No. 2, in which gluconic acid (potassium gluconate) was contained, resulted in lower strange taste strength than Test section No. 3. For Test section No. 2, there were comments such as “Odd taste was masked, and slightly sweet state”. As described above, it was found that even when the content of common salt in the bread is reduced, the strange taste strength can be reduced by the bread containing gluconic acid (potassium gluconate).

### 2.2. Test 2

Test 2 was performed to examine the influence of gluconic acid (potassium gluconate) on the taste under the condition where common salt was reduced.

### 2.2.1. Production of Bread

Raw materials were prepared at the blending ratio shown in Table 3, and roll breads were prepared so that the final product weighed 63 to 65 g. Specifically, first, raw materials other than butter (wheat flour, wheat protein, baker's yeast, sugar, common salt, whole egg, water, potassium gluconate) were put into a mixer and mixed at a low speed for 2 minutes and at a high speed for 7 minutes. Butter was then added and mixed at low speed for 1 minute and at high speed for 7 minutes to make a dough. Thereafter, floor time was taken at a temperature of 28° C. and a humidity of 75% RH for 40 minutes. Next, the dough was divided into 70 g, and rolled by hand at 30 to 50 revolutions as a guide so that the dough was molded. The molded dough was placed on a top plate, and fermentation was performed at a temperature of 38° C. and a humidity of 85% RH for 60 minutes. Next, the dough was fired in an oven at an upper flame of 210° C. and a lower flame of 210° C. for 12 minutes, and then cooled at normal temperature for 40 minutes. The resulting bread was then packaged with a quality retention agent (“Negamold”, Freund Corporation).

TABLE 3

| Test section No. | 5 | 6 | 7 | 8 | 9 | 10 | 11 | 12 | 13 |
|---|---|---|---|---|---|---|---|---|---|
| Wheat flour | 160 | 160 | 160 | 160 | 160 | 160 | 160 | 160 | 160 |
| Wheat protein | 40 | 40 | 40 | 40 | 40 | 40 | 40 | 40 | 40 |
| Baker's yeast | 2.2 | 2.2 | 2.2 | 2.2 | 2.2 | 2.2 | 2.2 | 2.2 | 2.2 |
| Sugar | 2.4 | 2.4 | 2.4 | 2.4 | 2.4 | 2.4 | 2.4 | 2.4 | 2.4 |
| Common salt | 6.04 | 2.01 | 0.67 | 0.20 | 0.20 | 0.20 | 0.20 | 0.20 | 0.20 |
| Whole egg | 30 | 30 | 30 | 30 | 30 | 30 | 30 | 30 | 30 |
| Water | 120 | 120 | 120 | 120 | 120 | 120 | 120 | 120 | 120 |
| Butter | 30 | 30 | 30 | 30 | 30 | 30 | 30 | 30 | 30 |
| Potassium gluconate | 0 | 0 | 0 | 0 | 0.05 | 0.21 | 2.61 | 5.22 | 10.43 |

The numerical values in the table are mass ratio.

### 2.2.2. Protein Analysis

The amount of protein in the bread (final product) of Test section No. 6 was determined (N=3) by the method described in the column 2.1.2. The measurement result of the protein amount of the bread in Test section No. 6 was 16.97 g/100 g on average. Using the value, the ratio of each of common salt, gluconic acid, and potassium gluconate with respect to the protein in each bread was calculated.

### 2.2.3. Measurement and Effect of Strange Taste Strength

For the strange taste of the bread, sensory evaluation was performed by 8 persons according to the same criteria as in 2.1.4. Based on this result, the improving effect of strange taste strength was determined for Test section No. 9 to 13. The determination results were determined as follows after discussion by the evaluators.
4: Very effective
3: Effective
2: Slightly effective
1: No effective

### 2.2.4. Measurement and Effect of Excessive Sweetness

Sensory evaluation was performed by focusing on excessive sweetness, which is one of the constituents of strange taste. Specifically, the obtained roll bread was cut into 8 equal pieces, and eaten such that one piece was eaten at a time. Sweetness remaining as an aftertaste and causing difficulty in eating was defined as “excessive sweetness”, and the strength of excessive sweetness was evaluated on a scale of 1 to 9 points shown below. The evaluation was performed by 8 persons skilled in the sensory test of taste, the sensory evaluation was performed explicitly indicating the content of each sample, and the average value thereof was calculated.
1: No excessive sweetness is felt.
2: Almost no excessive sweetness is felt.
3: Very slight excessive sweetness is felt.
4: Slight excessive sweetness is felt.
5: Excessive sweetness is felt.
6: Slightly strong excessive sweetness is felt.
7: Strong excessive sweetness is felt.
8: Considerably strong excessive sweetness is felt.
9: Very strong excessive sweetness is felt.

Based on the obtained result, the improving effect of excessive sweetness was determined for Test section No. 9 to 13. The determination results were determined as follows after discussion by the evaluators.
4: Very effective
3: Effective
2: Slightly effective
1: No effective

### 2.2.5. Measurement and Effect of Milk Fat Flavor

Sensory evaluation was performed by focusing on milk fat flavor, which is one of the constituents of strange taste. Specifically, the obtained roll bread was cut into 8 equal pieces, and eaten such that one piece was eaten at a time. A cheese-like taste scent or an oxidized oil scent like grease was defined as “milk fat flavor”, and the strength of milk fat flavor was evaluated on a scale of 1 to 9 points shown below. At the time of evaluation, attention was attracted so that flavors preferably present in bread, such as a milk-like sweet flavor or a butter-like flavor, were not evaluated. The evaluation was performed by 8 persons skilled in the sensory test of taste, the sensory evaluation was performed explicitly indicating the content of each sample, and the average value thereof was calculated.
1: No milk fat flavor is felt.
2: Almost no milk fat flavor is felt.
3: Very slight milk fat flavor is felt.
4: Slight milk fat flavor is felt.
5: Milk fat flavor is felt.
6: Slightly strong milk fat flavor is felt.
7: Strong milk fat flavor is felt.
8: Considerably strong milk fat flavor is felt.
9: Very strong milk fat flavor is felt.

Based on the obtained result, the improving effect of milk fat flavor was determined for Test section No. 9 to 13. The determination results were determined as follows after discussion by the evaluators.
4: Very effective
3: Effective
2: Slightly effective
1: No effective

### 2.2.6. Measurement and Effect of Metal Odor

Sensory evaluation was performed by focusing on metal odor, which is one of the constituents of strange taste. Specifically, the obtained roll bread was cut into 8 equal pieces, and eaten such that one piece was eaten at a time. A flavor such as iron or an artificial flavor was defined as “metal odor”, and the strength of metal odor was evaluated on a scale of 1 to 9 points shown below. The evaluation was performed by 8 persons skilled in the sensory test of taste, the sensory evaluation was performed explicitly indicating the content of each sample, and the average value thereof was calculated.
1: No metal odor is felt.
2: Almost no metal odor is felt.
3: Very slight metal odor is felt.
4: Slight metal odor is felt.
5: Metal odor is felt.
6: Slightly strong metal odor is felt.
7: Strong metal odor is felt.
8: Considerably strong metal odor is felt.
9: Very strong metal odor is felt.

Based on the obtained result, the improving effect of metal odor was determined for Test section No. 9 to 13. The determination results were determined as follows after discussion by the evaluators.
4: Very effective
3: Effective
2: Slightly effective
1: No effective

### 2.2.7. Results

Table 4 shows the results.

TABLE 4

| Test section No. | 5 | 6 | 7 | 8 | 9 | 10 | 11 | 12 | 13 |
|---|---|---|---|---|---|---|---|---|---|
| Ratio of common salt | 9.98% | 3.36% | 1.13% | 0.34% | 0.34% | 0.34% | 0.34% | 0.33% | 0.33% |
| with respect to protein | | | | | | | | | |
| Ratio of gluconic acid | 0.00% | 0.00% | 0.00% | 0.00% | 0.07% | 0.29% | 3.63% | 7.22% | 14.25% |
| with respect to protein | | | | | | | | | |
| Ratio of potassium | 0.00% | 0.00% | 0.00% | 0.00% | 0.09% | 0.35% | 4.34% | 8.63% | 17.03% |
| gluconate with respect | | | | | | | | | |
| to protein | | | | | | | | | |
| Mass ratio of gluconic | 0 | 0 | 0 | 0 | 0.21 | 0.87 | 10.87 | 21.74 | 43.44 |
| acid with respect to | | | | | | | | | |
| common salt | | | | | | | | | |
| Total content of common | 9.98% | 3.36% | 1.13% | 0.34% | 0.41% | 0.63% | 3.97% | 7.55% | 14.58% |
| salt and gluconic acid | | | | | | | | | |
| Strange taste strength | 3.3 | 3.9 | 5.4 | 6.6 | 5.9 | 5.7 | 3.7 | 3.4 | 5.4 |
| Improving effect of | — | — | — | — | 2 | 3 | 4 | 4 | 2 |
| strange taste strength | | | | | | | | | |
| Strength of excessive | 2.6 | 3.7 | 5.7 | 6.6 | 5.6 | 4.9 | 3.6 | 3.1 | 2.7 |
| sweetness | | | | | | | | | |
| Improving effect of | — | — | — | — | 3 | 3 | 4 | 4 | 4 |
| excessive sweetness | | | | | | | | | |
| Strength of milk | 3.0 | 4.4 | 5.9 | 6.7 | 5.7 | 4.9 | 3.6 | 2.9 | 3.0 |
| fat flavor | | | | | | | | | |
| Improving effect of | — | — | — | — | 3 | 3 | 4 | 4 | 4 |
| milk fat flavor | | | | | | | | | |
| Strength of metal odor | 3.3 | 3.0 | 3.6 | 4.4 | 4.1 | 4.1 | 3.6 | 3.1 | 3.3 |
| Improving effect | — | — | — | — | 2 | 2 | 3 | 3 | 2 |
| of metal odor | | | | | | | | | |

As shown in Test section No. 5 to 8, the strange taste strength tends to increase as the ratio of common salt with respect to protein is decreased. In particular, this tendency was remarkable for excessive sweetness and milk fat flavor. For Test section No. 5, there were comments such as “Good finish due to strong saltiness, hard, and a slight saltiness”. For Test section No. 6, there were comments such as “Strong milk feeling to make overall taste contour mild, and sweet taste as a pre-taste”. For Test section No. 7, there were comments such as “Slightly strong sweet taste, and strongly remaining sweetness and milk feeling due to fuzzy taste contour”. For Test section No. 8, there were comments such as “Strong sweet taste to make the taste loose, and strongly felt metal odor”.

For Test section No. 9 to 12, in which potassium gluconate was added to the formulation of Test section No. 8, the strange taste strength decreased as the amount of potassium gluconate was increased. However, for Test section No. 13, the strange taste strength increased as the amount of potassium gluconate was increased. The excessive sweetness decreased as the amount of potassium gluconate increased. Regarding milk fat flavor and metal odor, for Test section No. 9 to 12, the strength decreased as potassium gluconate was increased. However, for Test section No. 13, the strength increased.

For Test section No. 9, there were comments such as “Excessive sweetness is felt, but is slightly weaker than in Test section No. 4”. For Test section No. 10, there were comments such as “Slight sweetness remains, but is masked”. For Test section No. 11, there were comments such as “Excessive sweetness is significantly masked; and milk feeling and remaining excessive sweetness were felt, but did not last long”. For Test section No. 12, there were comments such as “Excessive sweetness is significantly masked; and strange taste was reduced due to decreased sweetness”. For Test section No. 13, there were comments such as “The taste turned flat, being close to natural taste; and there are strong bitterness and acridity derived from potassium”. From the above, it was found that even when the content of common salt is reduced, a bread to which potassium gluconate is added can be improved in strange taste strength.

### 2.3. Test 3

Test 3 was performed to examine the influence of the ratio of common salt and gluconic acid (potassium gluconate) on the taste under the condition where common salt was reduced.

### 2.3.1. Production of Bread

Raw materials were prepared at the blending ratio shown in Table 5, and roll breads were prepared so that the final product weighed 63 to 65 g. Specifically, first, raw materials other than butter (wheat flour, wheat protein, baker's yeast, sugar, common salt, whole egg, water, potassium gluconate) were put into a mixer and mixed at low speed for 2 minutes and at high speed for 5 minutes. Butter was then added and mixed at low speed for 2 minutes and at high speed for 7 minutes to make a dough. Thereafter, floor time was taken at a temperature of 28° C. and a humidity of 75% RH for 40 minutes. Next, the dough was divided into 70 g, and rolled by hand at 30 to 50 revolutions as a guide so that the dough was molded. The molded dough was placed on a top plate, and fermentation was performed at a temperature of 38° C. and a humidity of 85% RH for 60 minutes. Next, the dough was fired in an oven at an upper flame of 210° C. and a lower flame of 210° C. for 12 minutes, and then cooled at normal temperature for 60 minutes. The resulting bread was then packaged with a quality retention agent (“Negamold”, Freund Corporation).

TABLE 5

| Test section No. | 14 | 15 | 16 | 17 | 18 | 19 | 20 | 21 |
|---|---|---|---|---|---|---|---|---|
| Wheat flour | 160 | 160 | 160 | 160 | 160 | 160 | 160 | 160 |
| Wheat protein | 40 | 40 | 40 | 40 | 40 | 40 | 40 | 40 |
| Baker's yeast | 2.2 | 2.2 | 2.2 | 2.2 | 2.2 | 2.2 | 2.2 | 2.2 |
| Sugar | 2.4 | 2.4 | 2.4 | 2.4 | 2.4 | 2.4 | 2.4 | 2.4 |
| Common salt | 2.01 | 0.20 | 0.20 | 0.20 | 0.20 | 0.20 | 0.20 | 0.20 |
| Whole egg | 30 | 30 | 30 | 30 | 30 | 30 | 30 | 30 |
| Water | 120 | 120 | 119.5 | 120 | 120 | 120 | 120 | 120 |
| Butter | 30 | 30 | 30 | 30 | 30 | 30 | 30 | 30 |
| Potassium gluconate | 0 | 0 | 0.005 | 0.05 | 2.61 | 5.22 | 10.43 | 26.08 |

The numerical values in the table are mass ratio.

### 2.3.2. Protein Analysis

The amount of protein in the bread (final product) of Test section No. 14 was determined (N=3) by the method described in the column 2.1.2. The measurement result of the protein amount of the bread in Test section No. 14 was 10.8 g/100 g on average. Using the value, the ratio of each of common salt, gluconic acid, and potassium gluconate with respect to the protein in each bread was calculated.

### 2.3.3. Measurement and Effect of Strange Taste Strength

For the strange taste of the bread, sensory evaluation was performed by 8 persons according to the same criteria as in 2.1.4. Based on this result, the improving effect of strange taste strength was determined for Test section No. 16 to 21 according to the same criteria as in 2.2.3.

### 2.3.4. Measurement and Effect of Excessive Sweetness

Sensory evaluation was performed by focusing on excessive sweetness, which is one of the constituents of strange taste. Specifically, for the excessive sweetness of the bread, sensory evaluation was performed by 8 persons based on the same criteria as in 2.2.4. For Test section No. 16 to 21, the improving effect of excessive sweetness was determined.

### 2.3.5. Measurement and Effect of Milk Fat Flavor

Sensory evaluation was performed by focusing on milk fat flavor, which is one of the constituents of strange taste. Specifically, for the milk fat flavor of the bread, sensory evaluation was performed by 8 persons based on the same criteria as in 2.2.5. For Test section No. 16 to 21, the improving effect of milk fat flavor was determined.

### 2.3.6. Measurement and Effect of Metal Odor

Sensory evaluation was performed by focusing on metal odor, which is one of the constituents of strange taste. Specifically, for the metal odor of the bread, sensory evaluation was performed by 8 persons based on the same criteria as in 2.2.6. For Test section No. 16 to 21, the improving effect of metal odor was determined.

### 2.3.7. Results

Table 6 shows the results.

TABLE 6

| Test section No. | 14 | 15 | 16 | 17 | 18 | 19 | 20 | 21 |
|---|---|---|---|---|---|---|---|---|
| Ratio of common salt | 3.36% | 0.34% | 0.34% | 0.34% | 0.34% | 0.33% | 0.33% | 0.32% |
| with respect to protein | | | | | | | | |
| Ratio of gluconic acid | 0.00% | 0.00% | 0.01% | 0.07% | 3.62% | 7.19% | 14.19% | 34.12% |
| with respect to protein | | | | | | | | |
| Ratio of potassium gluconate | 0.00% | 0.00% | 0.01% | 0.09% | 4.34% | 8.63% | 17.03% | 40.96% |
| with respect to protein | | | | | | | | |
| Mass ratio of gluconic | 0 | 0 | 0.02 | 0.21 | 10.87 | 21.74 | 43.44 | 108.62 |
| acid with respect to | | | | | | | | |
| common salt | | | | | | | | |
| Total content of common | 3.36% | 0.34% | 0.35% | 0.41% | 3.96% | 7.52% | 14.52% | 34.44% |
| salt and gluconic acid | | | | | | | | |
| Strange taste strength | 3.6 | 6.1 | 5.6 | 4.4 | 3.8 | 2.9 | 3.9 | 6.5 |
| Improving effect of | — | — | 1 | 3 | 3 | 4 | 2 | 1 |
| strange taste strength | | | | | | | | |
| Strength of excessive | 3.1 | 5.0 | 4.9 | 4.0 | 3.4 | 2.8 | 2.4 | 3.3 |
| sweetness | | | | | | | | |
| Improving effect of | — | — | 1 | 2 | 3 | 4 | 4 | 2 |
| excessive sweetness | | | | | | | | |
| Strength of milk | 3.6 | 6.0 | 5.8 | 4.8 | 3.9 | 3.0 | 2.9 | 3.5 |
| fat flavor | | | | | | | | |
| Improving effect of | — | — | 1 | 2 | 3 | 4 | 3 | 1 |
| milk fat flavor | | | | | | | | |
| Strength of metal odor | 2.9 | 5.5 | 5.3 | 4.0 | 3.0 | 2.5 | 3.0 | 4.9 |
| Improving effect of | | | 2 | 3 | 4 | 4 | 3 | 1 |
| metal odor | | | | | | | | |

As can be seen from the comparison between Test section No. 14 and 15, the lower the ratio of common salt with respect to protein, the higher the strange taste strength. Excessive sweetness, milk fat flavor, and metal odor were more likely to appear. For Test section No. 14, there were comments such as “The pre-taste has an impact”. For Test section No. 15, there were comments such as “Milky cheese-like fatty acid odor and oil flavor were exhibited”, “There is sweetness, which makes the taste loose”, “A strange taste remains as aftertaste”, “Metal odor is felt as aftertaste”, and the like.

For Test section No. 16 to 21, in which potassium gluconate was added to the formulation of Test section No. 15, Test section No. 17 to 200 exhibited improving effects of strange taste strength, excessive sweetness, milk fat flavor, and metal odor. In Test No. 16, since the addition amount of potassium gluconate was small, strange taste strength, excessive sweetness, and milk fat flavor were insufficiently improved. In Test No. 21, since the addition amount of potassium gluconate was excessive, strange taste strength increased, and milk fat flavor and metal odor were insufficiently improved. For Test section No. 16, there were comments such as “The masking effect of potassium gluconate is insufficient because of cheese smell and excessive sweetness” and “Metal odor is slightly suppressed”. Test section No. 17 was rated high, and there were comments such as “Off-flavors such as excessive sweetness, fatty acid odor, and metal odor are moderately suppressed, and the taste is easily passed”. Test section No. 18 was rated high, and there were comments such as “There is less cheese odor felt”, “Both metal odor and excessive sweetness are considerably suppressed”. Test section No. 19 was rated high, and there were comments such as “Eaten easily” and “Little strange taste”. Test section No. 20 was rated relatively high, and there were comments such as “Exhibiting a little bit acridity”, “Having small off-flavor but exhibiting salty taste”. For Test section No. 21, there were comments such as “Acridity, bitterness, and grease-like oil odor are felt, and strange taste is generated, which is an inappropriate potassium gluconate concentration”, and “A little bit acridity”.

That is, from these results, it was found that in a bread containing a protein in a content of 11.0 mass % or more; and common salt in a content of 16.0 mass % or less with respect to the content of the protein, the improving effect of strange taste strength can be significantly remarkably exhibited when the mass ratio of gluconic acid satisfies the range of 0.08 or more and 43.5 or less, particularly 10.0 or more and 43.5 or less with respect to common salt.

As described above, the bread of the embodiment was able to provide a high-protein bread that maintains softness over time due to reduced common salt. In addition, the strange taste caused by reduced common salt was successively reduced by adding an appropriate amount of potassium gluconate as a raw material.

Although the embodiment has been described above, the above embodiment is for facilitating understanding of the present invention, and is not intended to limit the present invention. The present invention can be modified and improved without departing from the gist thereof, and the present invention includes equivalents thereof.

For example, in the above examples, a fermented bread obtained by adding yeast to the dough is exemplified, but the scope of the present invention encompasses breads other than fermented bread, such as a bread baked and inflated with a gas-generating inflating agent such as baking powder or baking soda. That is, as long as a dough containing the raw materials characteristic in the present invention is used, the bread is encompassed in the scope of the present invention regardless of the process of baking and inflating the dough.

1. A bread comprising:
a protein in a content of 11.0 mass % or more; and
common salt in a content of 0.1 mass % or more and 16.0 mass % or less with respect to the content of the protein.

2. The bread according to claim 1, further comprising gluconic acid,
wherein the gluconic acid is contained in a mass ratio of 0.08 or more and 43.5 or less with respect to the common salt.

3. The bread according to claim 2, wherein the common salt and the gluconic acid are contained in a total content of 0.4 mass % or more and 19.7 mass % or less with respect to the content of the protein.

4. The bread according to claim 1, having a stress of 2.0 N or more and 13.0 N or less.

5. The bread according to claim 1, wherein the protein is wheat protein.

6. A mix flour for bread comprising a protein and common salt,
wherein the common salt is contained in a content of 0.1 mass % or more and 16.0 mass % or less with respect to a content of the protein.

7. A method for producing a bread, the method comprising heating a dough containing the mix flour for bread according to claim 6 to produce a bread containing the protein in a content of 11.0 mass % or more.

8. (canceled)

9. (canceled)

10. A method of using common salt in a bread containing a protein in a content of 11.0 mass % or more, wherein
the common salt is used in a content of 0.1 mass % or more and 16.0 mass % or less with respect to the content of the protein.
